(19) United States
(12) Patent Application Publication
(10) Pub. No.: US 2026/0028861 A1
(43) Pub. Date: Jan. 29, 2026

(54) Handle Device and Vehicle

(71) Applicant: Illinois Tool Works Inc., Glenview, IL (US)

(72) Inventor: Penghui Yi, Shanghai (CN)

(21) Appl. No.: 19/276,884

(22) Filed: Jul. 22, 2025

(30) Foreign Application Priority Data
Jul. 25, 2024 (CN) 202411008913.8
Jul. 17, 2025 (CN) 202510990377.4

(51) Int. Cl. E05B 85/10; E05B 79/22; E05B 85/14

(52) U.S. Cl. CPC E05B 85/107; E05B 79/22; E05B 85/103; E05B 85/14

(57) ABSTRACT

A handle device and a vehicle includes a handle base, a handle, a first pushing member and a second pushing member. The handle comprises a handle body, a handle shaft, and an operating member, the operating member extends from the handle body, the handle body is translatably and rotatably mounted on the handle base relative to the handle base by means of the handle shaft, so as to be movable between a retracted position and a deployed position; the first pushing member is mounted translatably in a first direction on the handle base and operatively coupled with the handle body; and the second pushing member is configured to translate in a second direction different from the first direction under the drive of a driver, wherein the second pushing member is configured to operatively engage with the first pushing member and the operating member when translating in the second direction toward the first pushing member, to push the handle body to translate in the first direction by means of the first pushing member, and to push the handle body to rotate by means of the operating member, such that the handle body is moved from the retracted position to the deployed position. The handle device of the present disclosure has a movable rotating shaft, facilitating the handle to be deployed at a relatively small angle to the desired deployed position.

### RELATED APPLICATIONS

The present application claims the benefit of Chinese Patent Application Nos. 202411008913.8, filed Jul. 25, 2024, and 202510990377.4, filed Jul. 17, 2025, each titled “Handle Device and Vehicle,” the contents of which are hereby incorporated by reference.

### TECHNICAL FIELD

The present disclosure relates to a handle device and a vehicle having the handle device.

### BACKGROUND

In the prior art, a handle of a handle device for a vehicle has a retracted position and a deployed position. When the handle is in the retracted position, an outer surface of the handle is flush with outer sheet metal of the vehicle, such that an operator cannot unlock and open a vehicle door by pulling the handle. To open the vehicle door, a motor drives the handle, to move the handle from the retracted position to the deployed position. When the handle is in the deployed position, the handle extends out a certain distance relative to the outer sheet metal of the vehicle, providing sufficient room for the operator to pull the handle to unlock and open the door.

### SUMMARY

The present disclosure relates generally to a handle device, substantially as illustrated by and described in connection with at least one of the figures, as set forth more completely in the claims.

### BRIEF DESCRIPTION OF THE DRAWINGS

The features and advantages of the present disclosure can be better understood by reading the following detailed description with reference to the accompanying drawings. In all the accompanying drawings, the same reference numeral represents the same component. In the accompanying drawings:

FIG. 1A is a perspective view of a first embodiment of a handle device of the present disclosure in a retracted position.

FIG. 1B is an exploded view of the handle device shown in FIG. 1A.

FIG. 2A is an exploded view of a first pushing member and a handle base cooperating with each other in FIG. 1B.

FIG. 2B is an assembled view of the first pushing member and the handle base cooperating with each other in FIG. 1B.

FIG. 3A is a schematic view of a handle in FIG. 1B.

FIG. 3B is a cooperative schematic view between the handle and the first pushing member in FIG. 1B from a first perspective.

FIG. 3C is a cooperative schematic view between the handle and the first pushing member in FIG. 1B from a second perspective.

FIG. 4A is an exploded view of the handle, the first pushing member and a second pushing member in FIG. 1B from a first perspective.

FIG. 4B is an exploded view of the handle, the first pushing member and the second pushing member in FIG. 1B from a second perspective.

FIG. 4C is a cooperative schematic view between the handle, the first pushing member and the second pushing member in FIG. 1B from a first perspective.

FIG. 4D is a cooperative schematic view between the handle, the first pushing member and the second pushing member in FIG. 1B from a second perspective.

FIG. 5A is an exploded view of a handle driver and the second pushing member cooperating with each other in FIG. 1B.

FIG. 5B is an assembled view of the handle driver and the second pushing member cooperating with each other in FIG. 1B.

FIG. 6 is a schematic view of an unlocking device and the handle cooperating with each other in FIG. 1B.

FIG. 7A is a schematic view of a mounting position of a first return component.

FIG. 7B is a schematic view of a mounting position of a second return component.

FIG. 8A is a schematic view of the handle shown in FIG. 1A in a retracted position.

FIG. 8B is a schematic view of the handle shown in FIG. 1A in an extended position.

FIG. 8C is a schematic view of the handle shown in FIG. 1A during deployment.

FIG. 8D is a schematic view of the handle shown in FIG. 1A in the deployed position.

FIG. 9 is a partial schematic view of a second embodiment of a handle device of the present disclosure.

FIG. 10 is a partial schematic view of a third embodiment of a handle device of the present disclosure.

FIG. 11 is a schematic view of a vehicle provided with the handle device of the present disclosure.

FIG. 12 shows comparative diagrams of deployment angles of the handle device of the present disclosure and another embodiment of the handle device.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Through long-term observation and research, the inventor of the present disclosure has found that in the prior art, after the vehicle flush handle moves from the retracted position to the deployed position, the handle is deployed outwardly too far, resulting potential safety hazard (e.g., scratching pedestrians).

To at least partially solve above technical problems, according to an aspect of the present disclosure, a handle device comprises: a handle base; a handle; a first pushing member; and a second pushing member, a handle comprises a handle body, a handle shaft, and an operating member, the operating member extends from the handle body, the handle body is translatably and rotatably mounted on the handle base relative to the handle base by means of the handle shaft, so as to be movable between a retracted position and a deployed position; the first pushing member is mounted translatably in a first direction on the handle base and operatively coupled with the handle body; and the second pushing member is configured to translate in a second direction different from the first direction under the drive of a driver, wherein the second pushing member is configured to operatively engage with the first pushing member and the operating member when translating in the second direction toward the first pushing member, to push the handle body to translate in the first direction by means of the first pushing member, and to push the handle body to rotate by means of the operating member, such that the handle body is moved from the retracted position to the deployed position.

According to an aspect of the present disclosure, the handle shaft is rotatably connected to the first pushing member such that the first pushing member pushes the handle body to translate by means of the handle shaft.

According to an aspect of the present disclosure, the handle base is provided with a first slide groove, the handle shaft being mounted in the first slide groove and being rotatable and translatable in the first slide groove, wherein the first slide groove extends a predetermined distance in the first direction.

According to an aspect of the present disclosure, the handle base is provided with a second slide groove, the first pushing member being movably mounted on the second slide groove, wherein the second slide groove extends in the first direction.

According to an aspect of the present disclosure, the second pushing member comprises a first actuating portion and a second actuating portion, the first pushing member comprises a first actuated ramp, and the operating member comprises a second actuated ramp, wherein the first actuating portion and the first actuated ramp cooperate with each other to operatively engage the second pushing member with the first pushing member; and wherein the second actuating portion and the second actuated ramp cooperate with each other to operatively engage the second pushing member with the operating member.

According to an aspect of the present disclosure, the second actuating portion comes into contact with the second actuated ramp after the first actuating portion comes into contact with the first actuated ramp, so that the second pushing member first drives the handle body to translate and then drives the handle body to rotate.

According to an aspect of the present disclosure, the second pushing member further comprises a flat support surface disposed at a top thereof, the flat support surface supporting the first pushing member when the second pushing member drives the handle body to rotate.

According to an aspect of the present disclosure, the second actuating portion comes into contact with the second actuated ramp before the first actuating portion comes into contact with the first actuated ramp, so that the second pushing member first drives the handle body to rotate and then drives the handle body to translate.

According to an aspect of the present disclosure, the second actuating portion comes into contact with the second actuated ramp while the first actuating portion comes into contact with the first actuated ramp, so that the second pushing member drives the handle body to translate and rotate simultaneously.

According to an aspect of the present disclosure, the handle device further comprises a first return spring arranged to bias the handle shaft toward an initial translational position thereof.

According to an aspect of the present disclosure, the handle device further comprises a second return spring arranged to bias the handle body toward an initial rotational position thereof.

According to an aspect of the present disclosure, the handle device further comprises an unlocking device disposed in the handle base the handle further comprises an unlocking portion disposed on the operating member, wherein the unlocking portion abuts against the unlocking device to actuate the unlocking device for unlocking when the handle body is further rotated in a deployment direction from the deployed position.

According to an aspect of the present disclosure, the handle device further comprises the driver disposed in the handle base.

According to an aspect of the present disclosure, the first direction and the second direction are perpendicular to each other.

According to another aspect of the present disclosure, a vehicle comprises a handle device assembly according to an aspect of the present disclosure.

The handle device of the present disclosure has a movable rotating shaft relative to the handle base. During the movement of the handle body from the retracted position to the deployed position, the handle body not only translates outwardly but also rotates around the handle shaft, facilitating the handle body to be deployed at a relatively small angle to the desired deployed position from the retracted position, also facilitating a more reasonable space arrangement of the driver of the handle device in the door. In addition, the handle device of the present disclosure has a simple structure and is easy to mount and arrange.

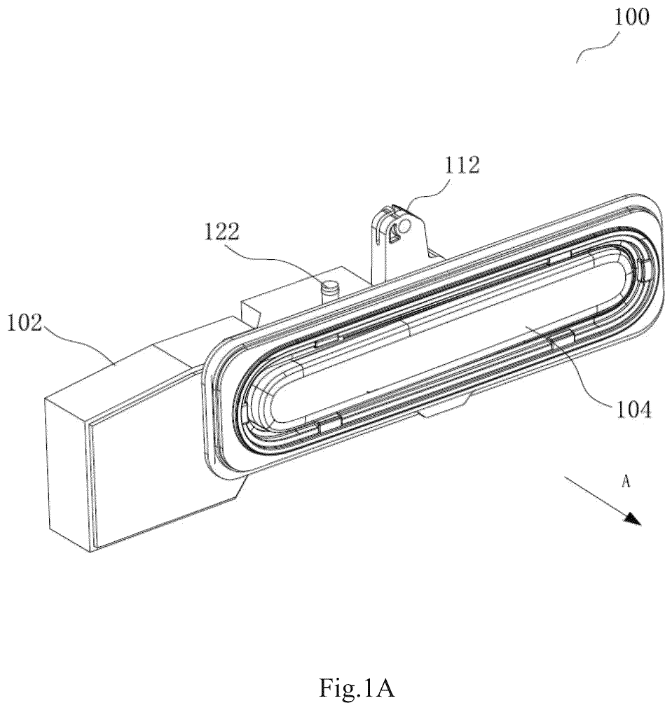

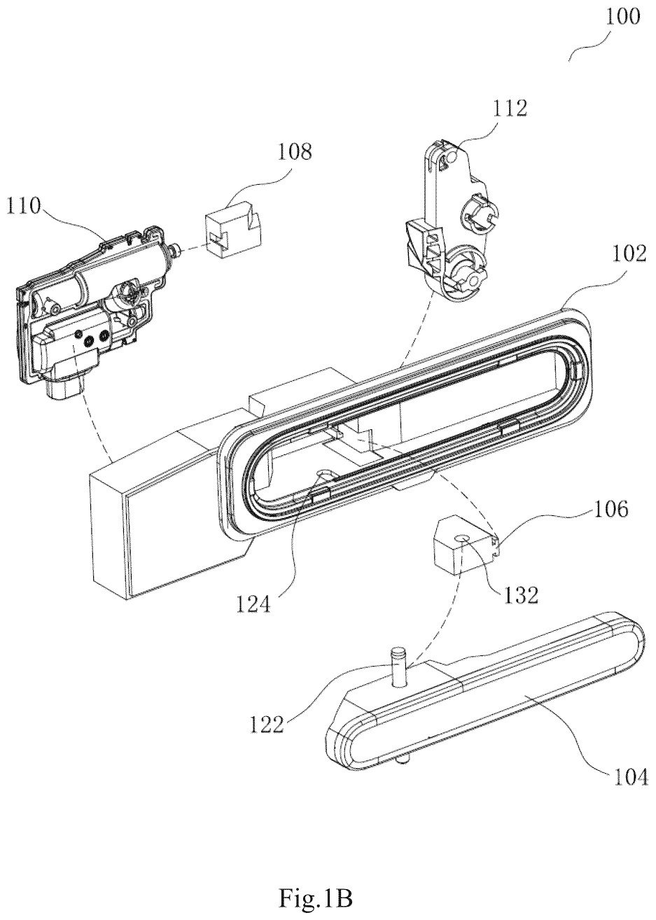

FIGS. 1A-1B show the specific structure of a first embodiment of a handle device of the present disclosure. FIG. 1A is a perspective view of the first embodiment of the handle device of the present disclosure in a retracted position; and FIG. 1B is an exploded view of the handle device in FIG. 1A. The direction of arrow A in FIG. 1A points to the outside of a door and the opposite direction of arrow A points to the inside of the door.

As shown in FIGS. 1A-1B, the handle device 100 has a handle base 102, a handle 104, a first pushing member 106, a second pushing member 108, a driver 110 and an unlocking device 112. The handle 104 is rotatably and translatably mounted in the handle base 102, and the handle 104 has a retracted position and a deployed position relative to the handle base 102 during movement. Specifically, the handle 104 includes a handle shaft 122, and the handle base 102 is provided with a first slide groove 124 for mounting the handle shaft 122, the first slide groove 124 having a groove width substantially the same as a shaft diameter of the handle shaft 122, so that the handle shaft 122 can be accommodated in the first slide groove 124 for rotation, thus the handle 104 can rotate relative to the handle base 102. The first slide groove 124 extends a predetermined distance in a first direction (e.g., in the direction of arrow A) to allow the handle shaft 122 to translate in the first direction in the first slide groove 124 such that the handle 104 translates relative to the handle base 102. The first pushing member 106 is disposed on the handle base 102 and is partially accommodated in an inner cavity of the handle 104. The first pushing member 106 is provided with a rotating shaft hole 132, and the handle shaft 122 is rotatably connected to the first pushing member 106 through the rotating shaft hole 132, so that the first pushing member 106 can push the handle 104 to translate by means of the handle shaft 122.

Still as shown in FIGS. 1A-1B, the second pushing member 108 and the driver 110 are disposed in the handle base 102, and the second pushing member 108 is operably connected to the driver 110. A push rod of the driver 110 may be extended and retracted in a second direction different from the first direction, so as to actuate the second pushing member 108 to reciprocate in the second direction (e.g., in a length direction of the handle device). The second pushing member 108 is operatively engaged with the first pushing member 106 and the handle 104 when translating in the second direction, so as to push the handle 104 to translate in the first direction by means of the first pushing member 106, and to push the handle 104 to rotate, such that the handle 104 is moved from the retracted position to the deployed position.

In an embodiment of the present disclosure, the second direction and the first direction are perpendicular to each other. It will be appreciated by those skilled in the art that in some other embodiments, the second direction and the first direction may be substantially perpendicular to each other or may be at other angles to each other.

Still as shown in FIG. 1A, the unlocking device 112 is disposed in the handle base 102, and the unlocking device 112 may be triggered when the handle 104 is further rotated in a deployment direction from the deployed position, to cause the unlocking device 112 to unlock the door.

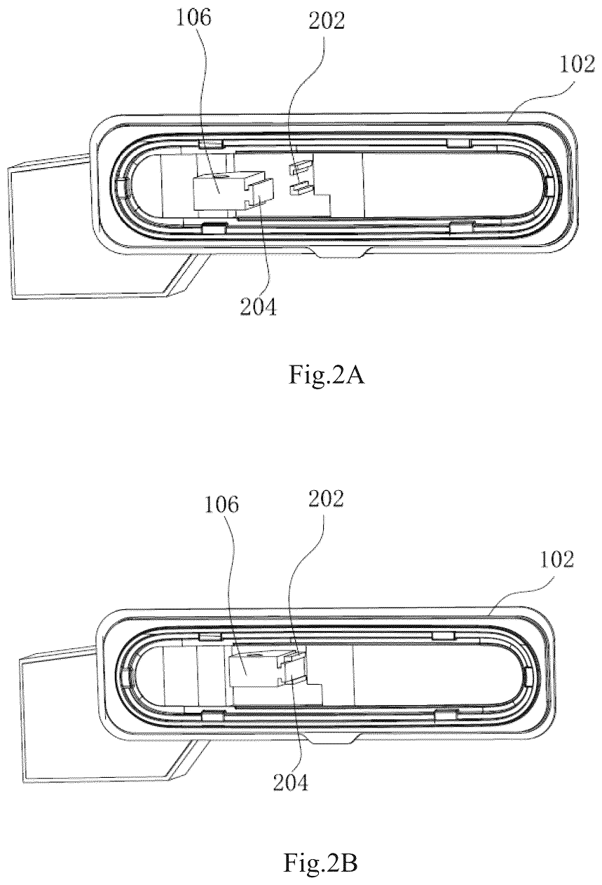

FIGS. 2A-2B show the cooperation between the first pushing member and the handle base. FIG. 2A is an exploded view of the first pushing member and the handle base of the handle device cooperating with each other; and FIG. 2B is an assembled view of the first pushing member and the handle base of the handle device cooperating with each other.

As shown in FIGS. 2A-2B, the handle base 102 is provided with a second slide groove 202, and the first pushing member 106 is provided with a slide groove mounting portion 204. The slide groove mounting portion 204 has an I-shaped cross-section, and is movably mounted on the second slide groove 202. The second slide groove 202 extends in the first direction for constraining the first pushing member 106 to translate in the first direction relative to the handle base 102.

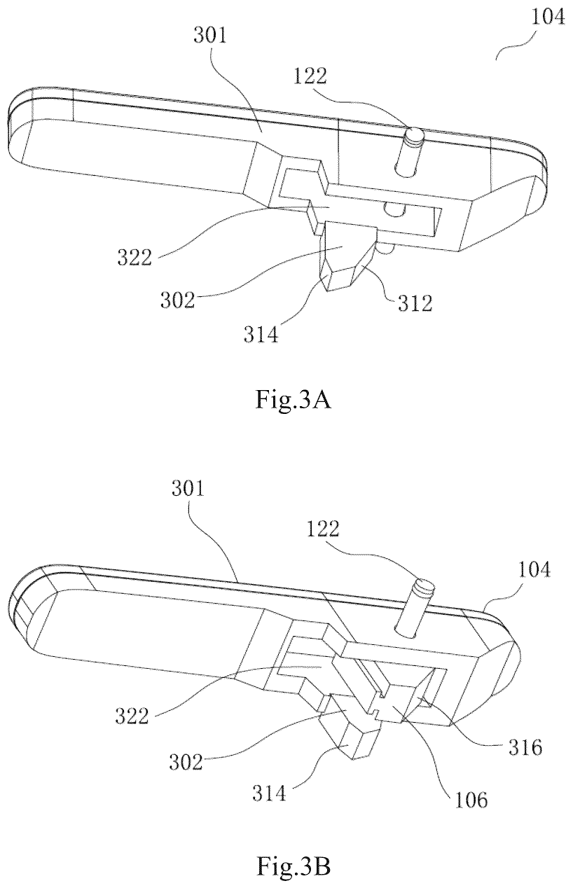

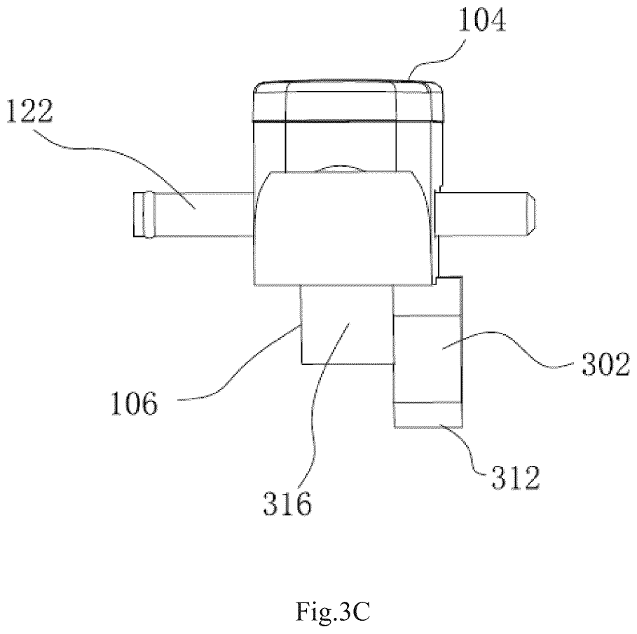

FIGS. 3A-3C show the structure of the handle and the manner in which the handle is connected to the first pushing member. FIG. 3A is a schematic view of the handle of the handle device; FIG. 3B is a cooperative schematic view between the handle and the first pushing member of the handle device from a first perspective; and FIG. 3C is a cooperative schematic view between the handle and the first pushing member of the handle device from a second perspective.

As shown in FIGS. 3A-3C, the handle 104 includes a handle body 301 and the handle shaft 122 as described above. The handle shaft 122 passes through the handle body 301 such that the handle body 301 can rotate around the handle shaft 122 or rotate together with the handle shaft 122, and the handle body 301 is thus translatably and rotatably mounted on the handle base relative to the handle base by means of the handle shaft 122, so as to be movable between the retracted position and the deployed position. The first pushing member 106 is operatively coupled with the handle body 301. A side of the handle 104 facing the inside of the door is provided with a handle inner cavity 322, the first pushing member 106 is partially accommodated in the handle inner cavity 322, and the handle shaft 122 passes through the rotating shaft hole 132 of the first pushing member 106, such that the handle body 301 can rotate relative to the first pushing member 106 by means of the handle shaft 122, the first pushing member 106 can push the handle body 301 to translate by means of the handle shaft 122, and the handle body 301 thus can move with the movement of the first pushing member 106.

It will be appreciated by those skilled in the art that in some other embodiments, since the handle shaft 122 is constrained to translate in the first direction in the first slide groove of the handle base, the handle shaft 122 may not pass through the rotating shaft hole of the first pushing member 106. It is only necessary to simply operably engaging (e.g., abutting) the first pushing member 106 with the handle body 301 such that the first pushing member 106 can apply a thrust force to the handle body 301 in a first direction with a line of action of the thrust force passing through the center of the handle shaft 122, the effect of pushing the handle body 301 to translate in the first direction by means of the first pushing member 106 can also be achieved.

Still as shown in FIGS. 3A-3C, the side of the handle 104 facing the inside of the door further includes an operating member 302. The operating member 302 is formed by extending from the handle body 301. The second pushing member 108 is operatively engaged with the first pushing member 106 and the operating member 302 when translating in the second direction toward the first pushing member 106, so as to push the handle body 301 to translate in the first direction by means of the first pushing member 106, and to push the handle body 301 to rotate by means of the operating member 302, such that the handle body 301 is moved from the retracted position to the deployed position. The first pushing member 106 includes a first actuated ramp 316, and the operating member 302 includes a second actuated ramp 312. The second pushing member 108 cooperates with or is operatively engaged with the first actuated ramp 316 and the second actuated ramp 312, respectively, thereby actuating the first pushing member 106 to translate, and the operating member 302 to rotate, respectively.

As shown in FIG. 3C, in a width direction of the handle 104, the first pushing member 106 is arranged side by side with the operating member 302. In various embodiments, the first pushing member 106 and the operating member 302 may be offset to different degrees in the height and length of the handle device such that the movement of the second pushing member 108 in the first direction can actuate the first pushing member 106 and the operating member 302 sequentially. In other embodiments, it is also possible that the first pushing member 106 and the operating member 302 are not offset in the height and length of the handle device such that the movement of the second pushing member 108 in the first direction can actuate the first pushing member 106 and the operating member 302 simultaneously.

Still as shown in FIGS. 3A-3C, the operating member 302 further includes an unlocking portion 314. The unlocking portion 314 may be another flat surface of the operating member 302 that is different from the second actuated ramp 312. When the handle body 301 is further rotated in the deployment direction from the deployed position, the unlocking portion 314 abuts against the unlocking device to actuate the unlocking device to unlock the door.

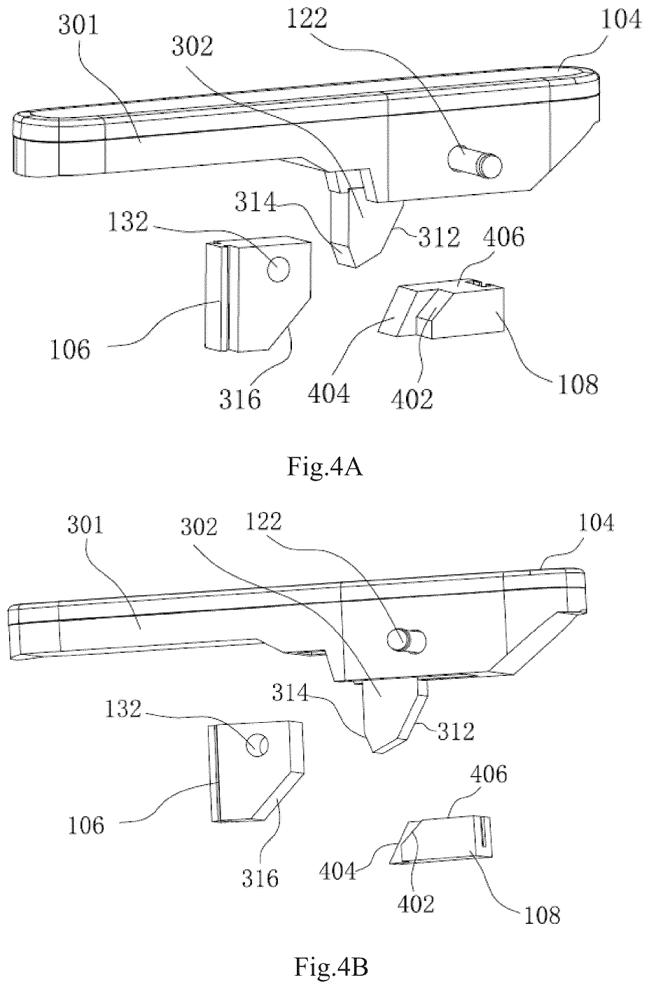

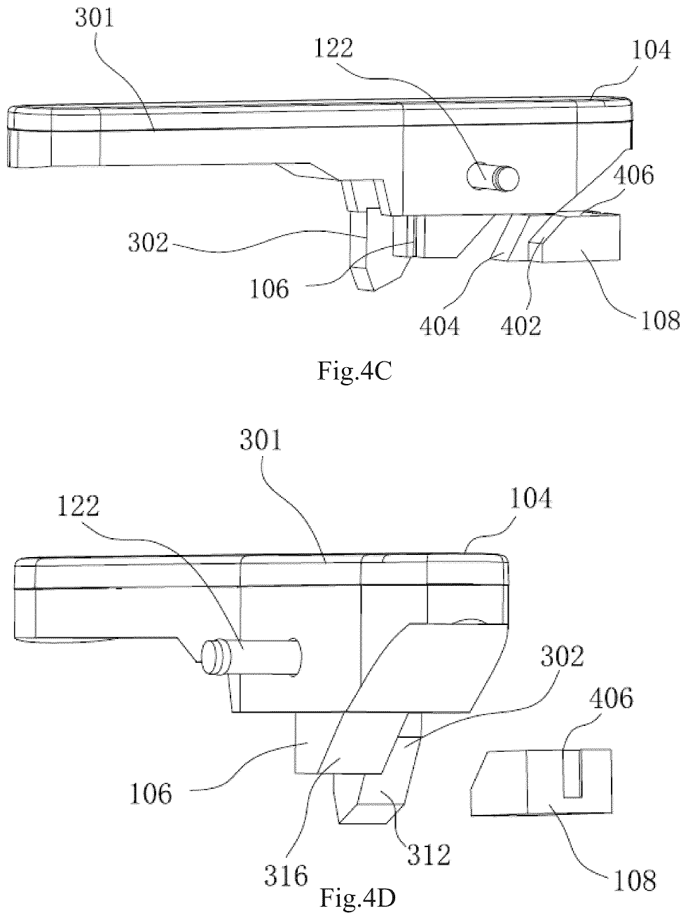

FIGS. 4A-4D show schematic views of the handle, the first pushing member and the pushing member cooperating with each other. FIG. 4A is an exploded view of the handle, the first pushing member and a second pushing member of the handle device from a first perspective; FIG. 4B is an exploded view of the handle, the first pushing member and the second pushing member of the handle device from a second perspective; FIG. 4C is a cooperative schematic view between the handle, the first pushing member and the second pushing member of the handle device from a first perspective; and FIG. 4D is a cooperative schematic view between the handle, the first pushing member and the second pushing member of the handle device from a second perspective.

As shown in FIGS. 4A-4D, the second pushing member 108 includes a first actuating portion 402 and a second actuating portion 404. In an embodiment of the present disclosure, the first actuating portion 402 and the second actuating portion 404 are ramps. As will be appreciated by those skilled in the art, it is also possible that either or both of the first actuating portion 402 and the second actuating portion 404 are rollers provided on the second pushing member 108. The first actuating portion 402 and the first actuated ramp 316 cooperate with each other to operatively engage the second pushing member 108 with the first pushing member 106; and the second actuating portion 404 and the second actuated ramp 312 cooperate with each other to operatively engage the second pushing member 108 with the operating member 302.

In the embodiment shown in FIGS. 4A-4D, the ramps of the first actuating portion 402 and the second actuating portion 404 are offset, i.e., the second actuating portion 404 protrudes a distance from the first actuating portion 402. In this way, during the movement of the second pushing member 108, the second actuating portion 404 comes into contact with the second actuated ramp 312 after the first actuating portion 402 comes into contact with the first actuated ramp 316. Therefore, the second pushing member 108 first drives the handle body 301 to translate, and then drives the handle body 301 to rotate after the translation of the handle body 301 is finished. The second pushing member 108 further includes a flat support surface 406 disposed at a top thereof. The flat support surface 406 is configured to support the first pushing member 106 when the second pushing member 108 drives the handle body 301 to rotate, so as to prevent the handle body 301 from translating in the reverse direction.

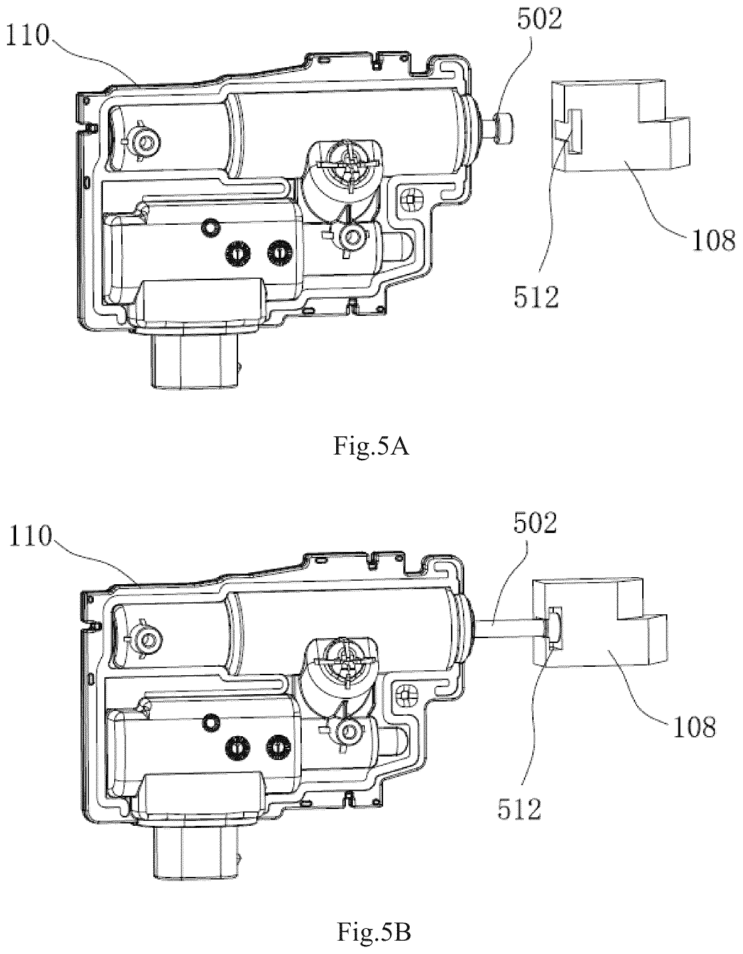

FIGS. 5A-5B show schematic views of a handle driver and the second pushing member cooperating with each other. FIG. 5A is an exploded view of the handle driver and the second pushing member of the handle device cooperating with each other; and FIG. 5B is an assembled view of the handle driver and the second pushing member of the handle device cooperating with each other.

As shown in FIGS. 5A-5B, the driver 110 of the present disclosure may be an actuator or a linear motor, which has a push rod 502. The driver 110 may actuate the push rod 502 to extend and retract. The second pushing member 108 is provided, on the side near the driver 110, with a connecting portion 512 for connecting the push rod 502, such that the extension and retraction of the push rod 502 can cause the second pushing member 108 to reciprocate in the second direction.

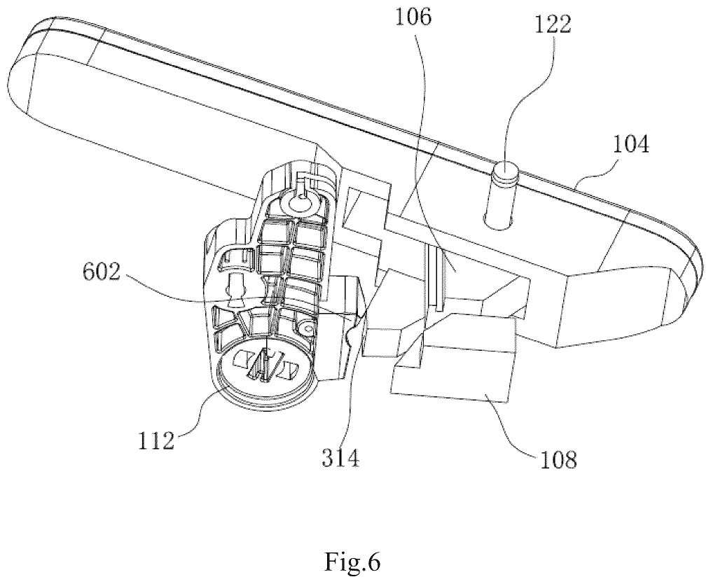

FIG. 6 is a schematic view of the unlocking device and the handle of the handle device cooperating with each other.

As shown in FIG. 6, the unlocking device 112 may be a pull-wire rocker arm for unlocking the door. The unlocking device 112 has a trigger portion 602. When the trigger portion 602 is triggered, the door unlocking function can be activated. When the handle 104 is in the deployed position, the unlocking portion 314 of the handle 104 is in contact with but does not squeeze the trigger portion 602 of the unlocking device 112, at which time if a user pulls the handle 104 in the deployment direction, the handle 104 will be further rotated from the deployed position, causing the unlocking portion 314 to squeeze the trigger portion 602, thereby triggering the trigger portion 602 to activate the door unlock function so that the user can open the door.

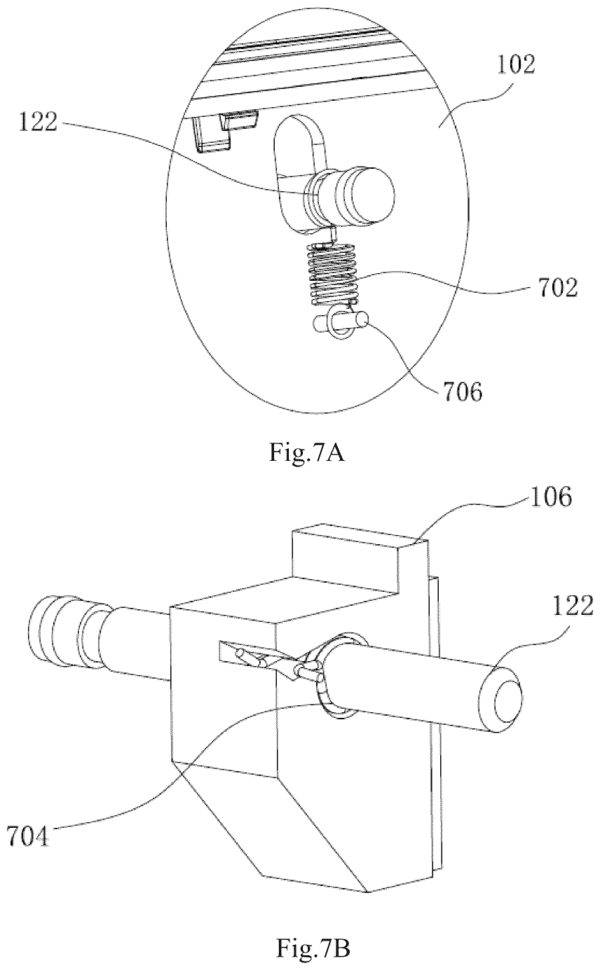

FIGS. 7A-7B show the specific structures of first and second return component. FIG. 7A is a schematic view of a mounting position of the first return component; and FIG. 7B is a schematic view of a mounting position of the second return component.

As shown in FIG. 7A, the handle device 100 further includes a first return spring 702 disposed between the handle shaft 122 and the handle base 102. The first return spring 702 has one end sleeved over the handle shaft 122 and the other end sleeved over a mounting protrusion 706 of the handle base 102, such that a return force applied between the handle shaft 122 and the handle base 102 can be provided. During the movement of the handle from the retracted position to the deployed position, the handle shaft 122 has an initial translational position and a final translational position, and the first return spring 702 biases the handle shaft 122 toward the initial translational position thereof.

As shown in FIG. 7B, the handle device 100 further includes a second return spring 704, such as a torsion spring, disposed between the handle and the first pushing member 106. The second return spring 704 has one end abutting against the first pushing member 106 and the other end abutting against the handle body (not shown in FIG. 7B), and the second return spring 704 is sleeved over the handle shaft 122. During the movement of the handle from the retracted position to the deployed position, the handle has an initial rotational position and a final rotational position. The second return spring 704 is arranged to bias the handle body toward the initial rotational position thereof.

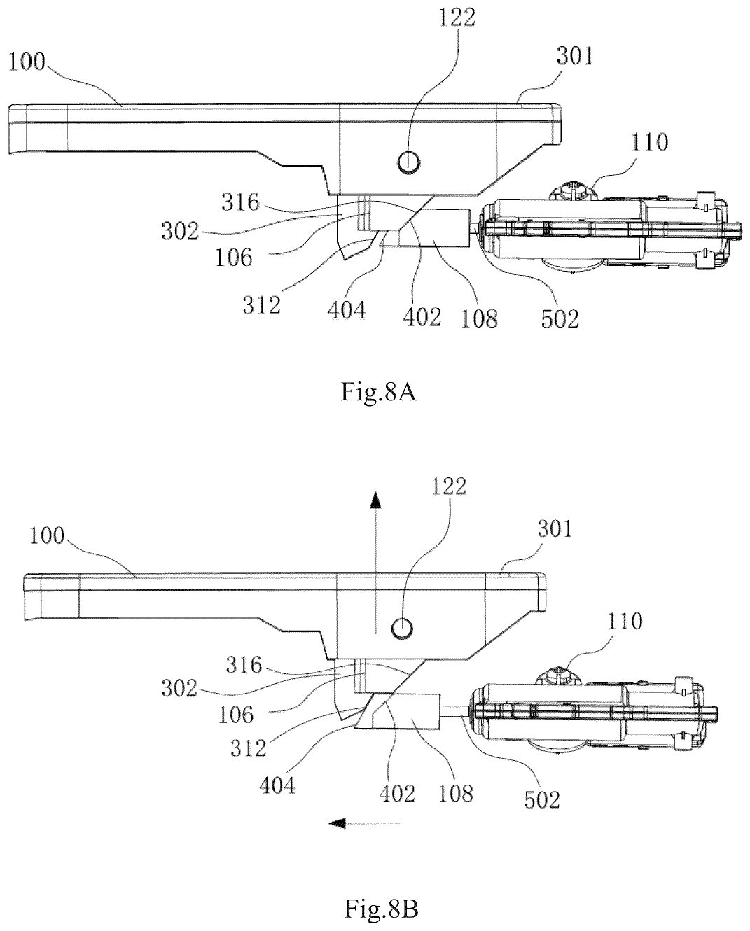

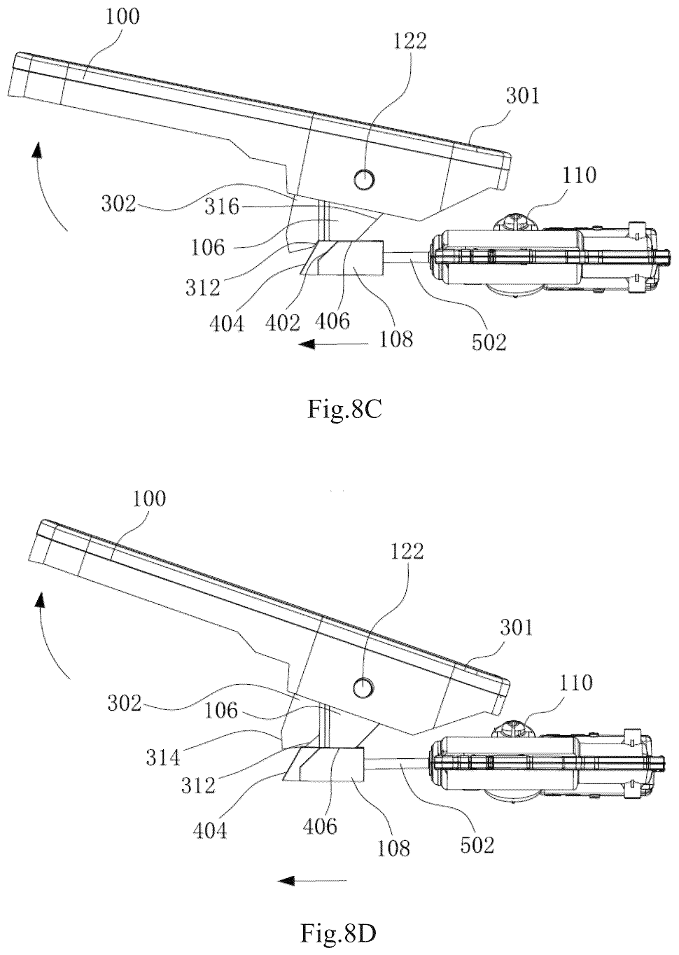

FIGS. 8A-8D show schematic views of the handle of the present disclosure moving from the retracted position to the deployed position. FIG. 8A is a schematic view of the handle in the retracted position; FIG. 8B is a schematic view of the handle in an extended position; FIG. 8C is a schematic view of the handle during deployment; and FIG. 8D is a schematic view of the handle in the deployed position.

As shown in FIG. 8A, when the handle device 100 is in the retracted position, the push rod 502 of the driver 110 is in the retracted position, and the first actuating portion 402 of the second pushing member 108 and the first actuated ramp 316 of the first pushing member 106 are in contact with each other. The second actuating portion 404 of the second pushing member 108 is not in contact with the second actuated ramp 312 of the operating member 302. The second actuating portion 404 is spaced apart from the second actuated ramp 312 by a distance. The first return component provides a return force to the handle shaft 122 to move it toward the initial translational position, so that the handle shaft 122, along with the first pushing member 106, is biased to an inner side position of the first slide groove.

As shown in FIG. 8B, the push rod 502 of the driver 110 extends from the retracted position, to push the second pushing member 108 to move in the second direction. The first actuating portion 402 of the second pushing member 108 and the first actuated ramp 316 of the first pushing member 106 abut against each other, such that the first actuated ramp 316 of the first pushing member 106 moves relative to the first actuating portion 402 of the second pushing member 108. Therefore, the movement of the second pushing member 108 in the second direction can be converted into the translation of the first pushing member 106 in the first direction. The translation of the first pushing member 106 in the first direction may push the handle shaft 122 to drive the handle body 301 to translate in the first direction, or the first pushing member 106 directly pushes the handle body 301 to translate in the first direction. In this case, the handle shaft 122 is translated to an outer side position of the first slide groove. When the first actuating portion 402 of the second pushing member 108 is moved to a position to be disengaged from the first actuated ramp 316 of the first pushing member 106, the second actuating portion 404 of the second pushing member 108 is about to come into contact with the second actuated ramp 312 of the operating member 302, and the handle device 100 is now in the extended position.

As shown in FIG. 8C, the push rod 502 of the driver 110 continues to extend from the extended position, continuing pushing the second pushing member 108 to move in the second direction. In this case, the first pushing member 106 is moved in the first direction above the flat support surface 406 of the second pushing member 108, and the second pushing member 108 no longer pushes the first pushing member 106 to move. Under the return force of the first return component, the first pushing member 106 abuts downwardly against the flat support surface 406 of the second pushing member 108. The second actuating portion 404 of the second pushing member 108 and the second actuated ramp 312 of the operating member 302 abut against each other such that the second actuating portion 404 of the second pushing member 108 can push the second actuated ramp 312 of the operating member 302, thereby causing the handle body 301 to rotate toward the final rotational position.

As shown in FIG. 8D, the push rod 502 of the driver 110 continues to extend from the rotational position shown in FIG. 8C, continuing pushing the second pushing member 108 to move in the second direction, and the flat support surface 406 of the second pushing member 108 slides relative to the first pushing member 106, thereby no longer pushing the first pushing member 106 to move. The second actuating portion 404 of the second pushing member 108 continues to push the second actuated ramp 312 of the operating member 302, causing the handle body 301 to rotate toward the final rotational position until the handle body 301 is rotated to the deployed position. In the deployed position of the handle body 301, the user's fingers can just extend into a gap between the handle body 301 and the handle base, so that the user can continue to pull the handle body 301 to rotate. When the handle body 301 continues to rotate in the deployed position, the handle unlocking portion 314 squeezes the trigger portion of the unlocking device, thereby triggering the trigger portion to activate the door unlocking function, so that the user can open the door.

In the embodiments described above, the first actuating portion 402 and the second actuating portion 404 of the second pushing member 108 are disposed offset from each other, thereby successively actuating the first actuated ramp 316 of the first pushing member 106 and the second actuated ramp 312 of the operating member 302, thereby achieving first translation and then rotation of the handle body 301. As will be appreciated by those skilled in the art, the above embodiment is merely to describe the movement of the handle body 301 by way of example and are not intended to limit the above-described movement of the handle body 301. It is possible, for example, to adjust the offset structure of the first actuating portion 402 and the second actuating portion 404, such that the handle body 301 is rotated first and then translated, or the handle body 301 is rotated and translated simultaneously. The above embodiments are all within the scope of protection of the inventive concept of the present disclosure.

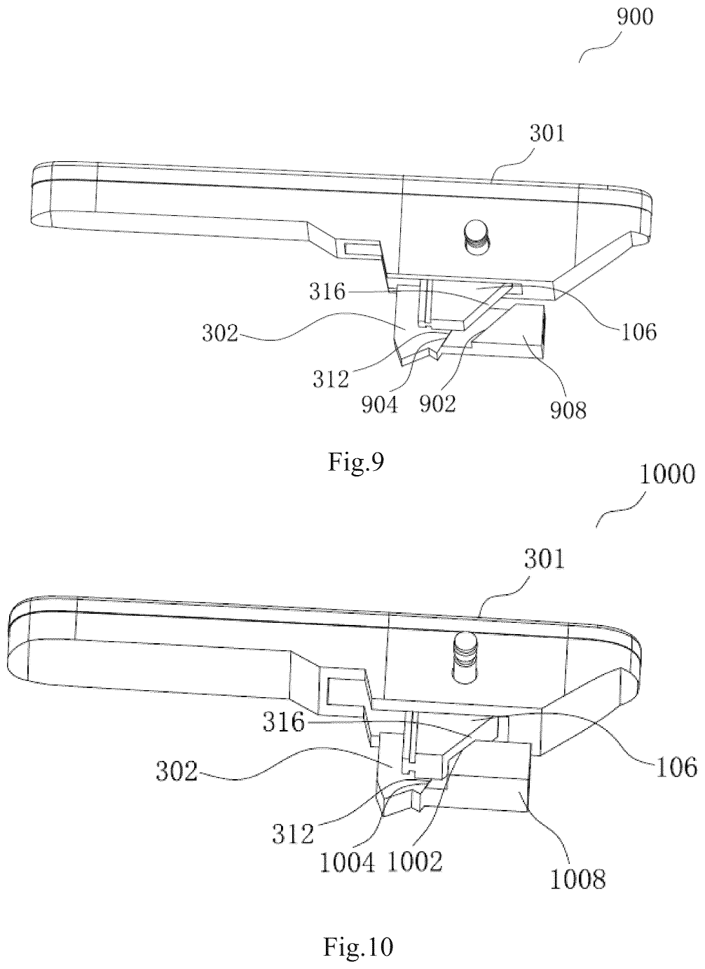

FIG. 9 is a partial schematic view of a second embodiment of a handle device of the present disclosure. The second embodiment of the handle device differs from the first embodiment in that the offset arrangement of the first actuating portion and the second actuating portion of the second pushing member is different, and the same parts will not be described again.

As shown in FIG. 9, the handle device 900 includes a second pushing member 908. A first actuating portion 902 and a second actuating portion 904 of the second pushing member 908 are disposed offset from each other. The second actuating portion 904 comes into contact with the second actuated ramp 312 before the first actuating portion 902 comes into contact with the first actuated ramp 316, so that the second pushing member 108 first drives the handle body 301 to rotate and then drives the handle body 301 to translate.

FIG. 10 is a partial schematic view of a third embodiment of a handle device of the present disclosure. The third embodiment of the handle device differs from the first embodiment in that the offset arrangement of the first actuating portion and the second actuating portion of the second pushing member is different, and the same parts will not be described again.

As shown in FIG. 10, the handle device 1000 includes a second pushing member 1008. A first actuating portion 1002 and a second actuating portion 1004 of the second pushing member 1008 are disposed offset from each other. The second actuating portion 1004 comes into contact with the second actuated ramp 312 while the first actuating portion 1002 comes into contact with the first actuated ramp 316, so that the second pushing member 108 drives the handle body 301 to translate and rotate simultaneously.

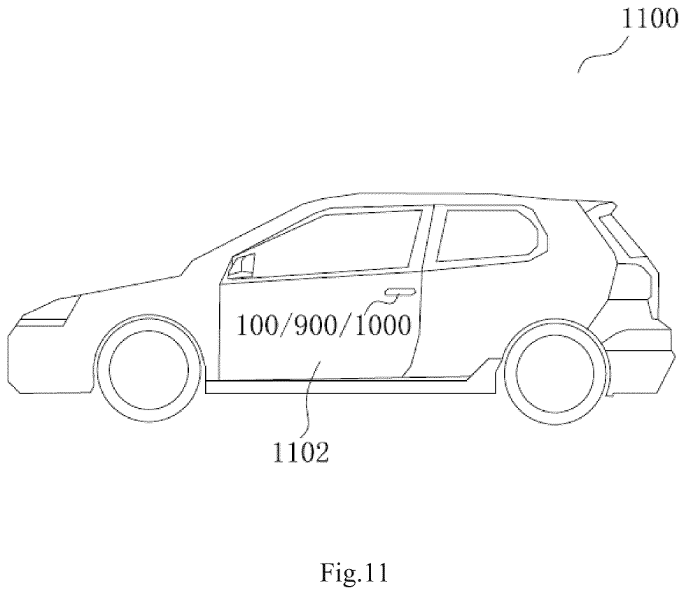

FIG. 11 is a schematic view of a vehicle provided with the handle device of the present disclosure.

As shown in FIG. 11, the vehicle 1100 includes the handle device 100/900/1000 described above. The vehicle 1100 has a door 1102, and the handle device 100/900/1000 is disposed on the door 1102. The vehicle 1100 is internally provided with a control device (not shown) that can identify the user's vehicle demand by receiving a user's instruction or by sensing, so as to send a control signal to the driver of the handle device to drive the handle to move from the retracted position to the deployed position.

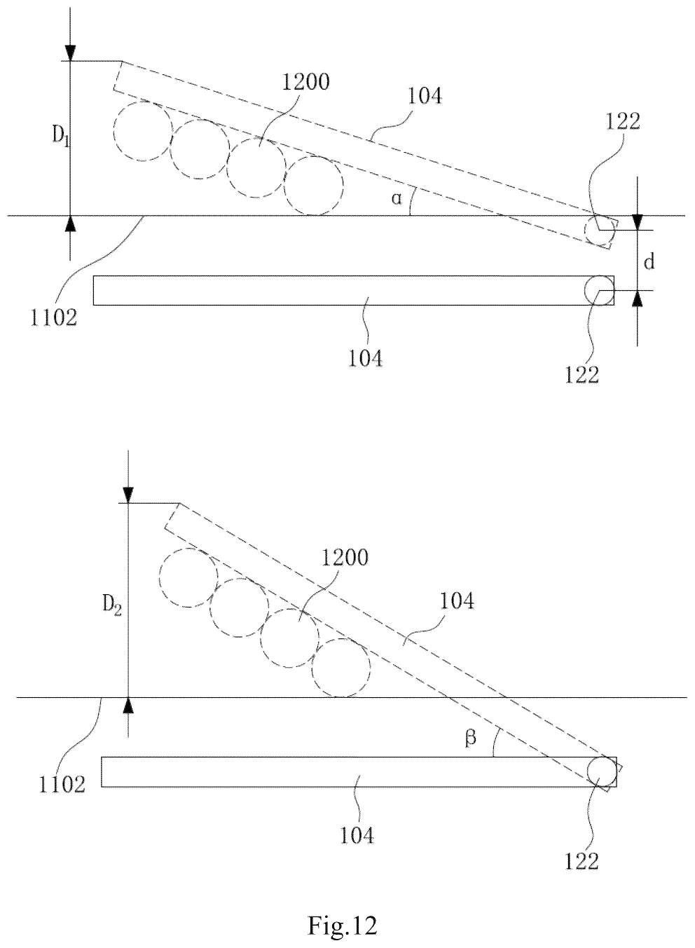

FIG. 12 shows comparative diagrams of deployment angles of the handle device of the present disclosure and another embodiment of the handle device, in which the upper diagram represents the schematic diagram of the deployment of the handle device of the present disclosure and the lower diagram represents the schematic diagram of the deployment of another embodiment of the handle device.

As described above, during the movement of the handle of the handle device of the present disclosure from the retracted position to the deployed position, the handle translates first and then rotates toward the outer side of the door, so that the handle can be deployed at a relatively small angle, and sufficient space can be provided to allow the user's fingers to access. If, during the movement from the retracted position to the deployed position, the handle is directly rotated relative to the door without translating to the outer side of the door, it is necessary to deploy the handle at a relatively large angle to provide sufficient space to allow the user's fingers to access.

As shown in the upper diagram in FIG. 12, in the present disclosure, the handle 104 and the handle shaft 122 thereof are translated from the retracted position to the outer side of the door by a distance d (e.g., 8 mm) and rotated. As shown by the dashed line in the diagram, when the angle of rotation reaches a (e.g., 20°), the handle 104 can provide sufficient space to allow the user's fingers 1200 to access. In this case, the most distal end of the handle 104 deployed extends relative to an outer surface of the door 1102 by a distance D1 of 40 mm.

As shown in the lower diagram of FIG. 12, in another embodiment of the handle device, the handle 104 is directly rotated from the retracted position without translation. If providing sufficient space to allow the user's fingers 1200 to access, the angle of rotation of the handle 104 needs to reach β (e.g., 35°), as shown by the dashed line in the diagram. In this case, the most distal end of the handle 104 deployed extends relative to the outer surface of the door 1102 by a distance D2 of 60 mm, which is significantly greater than the extended distance (D1) of the handle 104 in the present disclosure.

As will be known to those skilled in the art, the translation distance d and the angle of rotation α of the handle, and the distance D1 by which the most distal end of the handle deployed extends relative to the outer surface of the door can be adaptively adjusted on different types of handle devices, and are not limited to the above dimensions, as long as the principles of the inventive concept are met.

With the development of electric vehicles, door handles are designed as flush handles. In a non-use state, the handles are flush with or lower than the outer surface of the door and retracted to the inner side of the outer surface of the door. When opening the door, the control system of the vehicle can control the handle to be deployed outwardly from the retracted position, so that a driver or a passenger can pull the handle to open the door. However, for safety reasons (e.g., preventing pedestrians from being scratched), the handle cannot be deployed outwardly too far, but sufficient space must be provided for the user's hand to access and open the door. For pivotally deployed handles, it is necessary to make a rotating shaft of the handle as close to the outer surface of the door as possible, thereby making the deployment easier. However, in order to reserve a reasonable and sufficient space for the arrangement of the driver (e.g., a motor, a driving rod and other components) of the handle, the driver of the handle cannot be arranged too close to the outer surface of the door.

According to the above requirements, the handle device of the present disclosure has a movable rotating shaft. In the non-use state (a retracted state of the handle), the rotating shaft of the handle is close to the inner side of the door. In the use state (a deployed state of the handle), the handle together with the rotating shaft of the handle can be moved to a position close to the outer side of the door, thereby facilitating the handle to be deployed at a relatively small angle to the desired deployed position. Compared with the handle device that only rotates, sufficient space can be provided to allow the user's fingers to access by extending the handle a smaller distance relative to the outer surface of the door, so that the safety performance of the handle device is higher. Compared with the handle device that only translates, the handle is deployed outwardly at a certain angle to facilitate the user to identify a pulling end of the handle body.

Furthermore, since the handle of the present disclosure together with the rotating shaft of the handle can be translated toward the outer side of the door, the handle device can be disposed closer to the inner side of the door, facilitating a more reasonable space arrangement of the driver of the handle device in the door.

In addition, the handle device of the present disclosure has a simple structure and is easy to mount and arrange.

Any above-cited patents and patent publications are hereby incorporated by reference in their entirety. While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE SIGNS

Handle Device 100/900/1000
Handle Base 102
Handle 104
First Pushing Member 106
Second Pushing Member 108/908/1008
Driver 110
Unlocking device 112
Handle Shaft 122
First Slide Groove 124
Rotating Shaft Hole 132
Second Slide Groove 202
Slide Groove Mounting Portion 204
Handle Body 301
Operating Member 302
Second Actuated Ramp 312
Unlocking Portion 314
First Actuated Ramp 316
Handle Inner Cavity 322
First Actuating Portion 402/902/1002
Second Actuating Portion 404/904/1004
Flat Support Surface 406
Push Rod 502
Connecting Portion 512
Trigger Portion 602
First Return Spring 702
Second Return Spring 704
Mounting Protrusion 706
Vehicle 1100
Door 1102
User's Finger 1200

What is claimed is:

1. A handle device, comprising:
a handle base;
a handle comprising a handle body, a handle shaft, and an operating member, the operating member extending from the handle body, the handle body being translatably and rotatably mounted on the handle base relative to the handle base by means of the handle shaft, so as to be movable between a retracted position and a deployed position;
a first pushing member mounted translatably in a first direction on the handle base and operatively coupled with the handle body; and
a second pushing member configured to translate in a second direction different from the first direction under the drive of a driver,
wherein the second pushing member is configured to operatively engage with the first pushing member and the operating member when translating in the second direction toward the first pushing member, to push the handle body to translate in the first direction by means of the first pushing member, and to push the handle body to rotate by means of the operating member, such that the handle body is moved from the retracted position to the deployed position.

2. The handle device according to claim 1, wherein the handle shaft is rotatably connected to the first pushing member such that the first pushing member pushes the handle body to translate by means of the handle shaft.

3. The handle device according to claim 1,
wherein the handle base is provided with a first slide groove, the handle shaft being mounted in the first slide groove and being rotatable and translatable in the first slide groove, and
wherein the first slide groove extends a predetermined distance in the first direction.

4. The handle device according to claim 1,
wherein the handle base is provided with a second slide groove, the first pushing member being movably mounted on the second slide groove, and
wherein the second slide groove extends in the first direction.

5. The handle device according to claim 1,
wherein the second pushing member comprises a first actuating portion and a second actuating portion, the first pushing member comprises a first actuated ramp, and the operating member comprises a second actuated ramp,
wherein the first actuating portion and the first actuated ramp cooperate with each other to operatively engage the second pushing member with the first pushing member; and
wherein the second actuating portion and the second actuated ramp cooperate with each other to operatively engage the second pushing member with the operating member.

6. The handle device according to claim 5, wherein the second actuating portion comes into contact with the second actuated ramp after the first actuating portion comes into contact with the first actuated ramp, so that the second pushing member first drives the handle body to translate and then drives the handle body to rotate.

7. The handle device according to claim 6, wherein the second pushing member further comprises a flat support surface disposed at a top thereof, the flat support surface supporting the first pushing member when the second pushing member drives the handle body to rotate.

8. The handle device according to claim 5, wherein the second actuating portion comes into contact with the second actuated ramp before the first actuating portion comes into contact with the first actuated ramp, so that the second pushing member first drives the handle body to rotate and then drives the handle body to translate.

9. The handle device according to claim 5, wherein the second actuating portion comes into contact with the second actuated ramp while the first actuating portion comes into contact with the first actuated ramp, so that the second pushing member drives the handle body to translate and rotate simultaneously.

10. The handle device according to claim 2, further comprising:
a first return spring arranged to bias the handle shaft toward an initial translational position thereof.

11. The handle device according to claim 2, further comprising:
a second return spring arranged to bias the handle body toward an initial rotational position thereof.

12. The handle device according to claim 1, further comprising:
an unlocking device disposed in the handle base,
the handle further comprising an unlocking portion disposed on the operating member,
wherein, the unlocking portion abuts against the unlocking device to actuate the unlocking device for unlocking when the handle body is further rotated in a deployment direction from the deployed position.

13. The handle device according to claim 1, further comprising:
the driver disposed in the handle base.

14. The handle device according to claim 1, wherein the first direction and the second direction are perpendicular to each other.

15. A vehicle, comprising a handle device of claim 1.
